(19) United States
(12) Patent Application Publication
(10) Pub. No.: US 2025/0344788 A1
(43) Pub. Date: Nov. 13, 2025

(54) DETACHABLE CHARACTER PATCH AND METHOD FOR DECORATING USING THE SAME

(71) Applicant: Sang Jin KIM, Seoul (KR)

(72) Inventors: Sang Jin KIM, Seoul (KR); Chul JUNG, Gyeonggi-do (KR)

(21) Appl. No.: 18/019,997

(22) PCT Filed: Dec. 28, 2022
(86) PCT No.: PCT/KR2022/021558

§ 371 Date: Jan. 8, 2025

(51) Int. Cl. A41D 27/08; A42B 1/004; B44C 1/10; B44C 3/02

(52) U.S. Cl. CPC A41D 27/08; A42B 1/004; B44C 1/105; B44C 3/02

(57) ABSTRACT

A detachable character patch has a front surface printed with various figures, characters, marks, characters as 3D or dynamic images, and a back surface configured of a detachable material. The functional detachable character patch has the first layer having the front surface that includes the image and the back surface that is made of the Velcro, the second layer having the front surface that is made of velcro capable of being attached to the velcro of the first layer and the back surface to which the layer including a functional liquid component attached, and the third layer having the front surface that is the adhesive surface attached to the back surface of the second layer and the back surface that is configured of the base patch for mounting on the application target includes the functional components such as the volatile antibacterial component, the aromatic component, or the deodorizing component.

### CROSS REFERENCE TO RELATED APPLICATIONS AND CLAIM OF PRIORITY

This application claims benefit under 35 U.S.C. 119, 120, 121, or 365 (c), and is a National Stage entry from International Application No. PCT/KR2022/021558 filed on Dec. 28, 2022, the entire contents of which are incorporated herein by reference.

### BACKGROUND

### 1. Technical Field

The present invention relates to a detachable character patch and a method for decorating using the same, and more specifically, relates to a functional detachable character patch of which a front surface is printed with various figures, characters, marks, characters, etc. as 3D images or dynamic images, and a back surface is configured of a detachable material and added with functionality such as an antibacterial component, a fragrance component, and a deodorizing component, and a method for decorating clothes, bags, hats, masks, vehicles, mobile phones, electronic devices, furniture, etc. using the same.

### 2. Background Art

In general, character patches are widely used as external decorations by being attached to clothes, bags, hats, etc. to have various figures, letters, marks, and characters printed on the front surface and to satisfy various tastes of consumers.

These character patches are integrally attached to clothes, bags, hats, etc. through stitching by sewing. However, since the character patch according to the prior art adopts a structure in which it is integrally attached to clothes, bags, hats, etc. by sewing, there is a problem that it is difficult for unskilled people, for example, men and women of all ages, who are not experts, to attach character patches using the stitching method.

On the other hand, there is a problem in that work efficiency is reduced due to the hassle of stitching and attaching character patches in manufacturing factories that mass-produce clothes, bags, hats, etc.

Furthermore, there is a problem that wrinkles are formed on the character patch and defective products that are not smoothly attached by sewing the character patch often occur, and in order to change the character after attaching it by sewing, there is a hassle of having to remove the patch sewn by sewing with a skilled technique and then sew it on again.

In general, hats are recognized as a part of fashion in everyday life and are used favorably beyond their original function of simply protecting the user's head or the user's face from direct sunlight.

For this reason, various patterns may be embroidered on the front surface of the hat by using paints of a predetermined color or by printing, but it is not enough to attract attention or express one's own unique personality to that extent.

Alternatively, if various shapes or patterns are incorrectly put into the hat, there is a disadvantage in that the dignity of the hat may be lowered or various design changes cannot be brought about, and it makes the user easily bored, eventually, consumers will not be able to arouse the desire to buy hats.

Therefore, in this case, even if the shape or pattern is discolored due to long use, it cannot be replaced, and if consumers get bored with the accessory, the consumers will not use the hat. Therefore, hats to which various accessories may be attached to and detached by being selected according to consumer's taste are required.

Therefore, in the present invention, while continuing research to develop a functional patch with additional functionality, to which the character patch may be easily attached and detached, the present invention was completed by discovering the fact that a detachable character patch of which a front surface is printed with various figures, characters, marks, characters, etc. as 3D images or dynamic images, and a back surface is configured of a detachable material, and a functional detachable character patch added with functionality may be easily attached and detached to and from clothes, bags, hats, masks, wallets, vehicles, mobile phones, electronic devices, furniture, etc.

### SUMMARY

Therefore, a technical problem to be solved by the present invention is to provide a character patch that may be easily attached and detached.

Another technical problem to be solved by the present invention is to provide a functional detachable character patch in which functionality is added to the character patch.

In addition, further another technical problem to be solved by the present invention is to provide a method for decorating using the detachable character patch.

In order to solve the above technical problem, the present invention provides a detachable character patch wherein a front surface is printed with a character 3D image or a dynamic image, and a back surface is configured of a detachable velcro.

In order to solve the above other technical problems, in the present invention,

(1) a first layer having a front surface that is printed with a 3D character image or a dynamic image, and a back surface that is made of detachable velcro;

(2) a second layer having a front surface that is made of velcro capable of being attached to the velcro of the first layer, and a back surface to which a layer including a functional component is attached; and

(3) a third layer having a front surface that is an adhesive surface attached to the layer including the functional component of the second layer, and a back surface that is configured of a base patch for mounting on an application target,
are provided in a functional detachable character patch.

Preferably, wherein when the velcro on the back surface of the first layer is velours, the velcro on the front surface of the second layer is a crochet, and when the velcro on the back surface of the first layer is crochet, the velcro on the front surface of the second layer is velours.

Preferably, the layer including the functional component is a liquid layer including a volatile antibacterial component, an aromatic component, or deodorizing component, or a fabric layer impregnated or sprayed with volatile antibacterial component, an aromatic component, or a deodorizing component.

In addition, in order to solve the above technical problem, the present invention provides a method for decorating clothes, bags, hats, masks, wallets, vehicles, mobile phones, electronic devices, or furniture by using the functional detachable character patch.

In addition, the present invention provides a detachable accessory hat decorated by using the detachable character patch.

Preferably, the detachable accessory hat includes
a cap body (100) formed of a hemispherical body portion (110), and configured of a cap portion (120) protruding forward from a lower end of the body portion (110);
a hat decoration (200) mounted on the cap body (100), made in a thin and flat shape so as to be capable of being easily bent and adhered to the cap body (100) when mounted on the cap body (100);
a first attaching and detaching means (300) mounted on the detachable character patch (200), made of nylon by mold injection, and having a plurality of plastic hook protrusions (310) formed on a front surface thereof;
a second attaching and detaching means (400) mounted on the hat body (100) and having a plurality of loops (410) formed by weaving a polyester material by a knitting method and then performing nap processing; and
a third attaching and detaching means (500) where an opening (150) is openly formed in the hat body (100), and which is provided inside the hat body (100) along a circumference of the opening (150), in the third attaching and detaching means (500), a
plurality of loops are formed through nap processing after weaving the fabric by a knitting method,
the second attaching and detaching means (400) includes
an exposed portion (400a) to which the hat decoration (200) is detachably coupled; and
a coupling portion (400b) provided along a circumference of the exposed portion (400a) and detachably coupled to the third attaching and detaching means (500), and
the hook protrusion (310) includes
a plurality of support portions (311) formed by protruding upward and spaced apart from each other at regular intervals; and
a locking portion (312) protruding away from a front end of the support portion (311) in a width direction and formed in an upwardly convex arc shape.

Preferably, the hat decoration 200 made of the fiber material is the detachable character patch.

As described above, since the detachable character patch according to the present invention is made of velcro, it has an advantage that it may be easily attached and detached when a character is desired to be changed. In addition, the functional detachable character patch of the present invention configured of the first layer having the front surface that includes the image and the back surface that is made of the velcro; the second layer having the front surface that is made of velcro capable of being attached to the velcro of the first layer and the back surface to which the layer including a functional liquid component attached; and (3) the third layer having the front surface that is the adhesive surface attached to the back surface of the second layer and the back surface that is configured of the base patch for mounting on the application target includes the functional components such as the volatile antibacterial component, the aromatic component, or the deodorizing component. Therefore, the functional detachable character patch may be easily applied to various targets such as clothes, bags, hats, masks, vehicles, mobile phones, electronic devices, or furniture. Accordingly, the detachable character patch according to the present invention is easy to attach and detach, so that anyone may easily decorate clothes, bags, hats, masks, mobile phones, etc. in various ways according to the degree of preference, and may easily change the character at any time. In addition, the functional detachable character patch may be applied to various targets such as clothes, bags, hats, masks, vehicles, mobile phones, electronic devices, or furniture to obtain desired functional effects, and may be expected to be very useful in the relevant field.

### BRIEF DESCRIPTION OF THE DRAWINGS

FIG. 1 is a sectional view showing a structure of a detachable character patch of the present invention.

FIG. 2 is a view showing an example of the detachable character patch of the present invention.

FIG. 3 a view showing an actual example of a structure configured of a front surface and a back surface on which characters are printed in the detachable character patch of the present invention.

FIG. 4 is a sectional view showing a structure of a functional detachable character patch of the present invention.

FIG. 5 is a view showing an example of a functional detachable character patch of the present invention.

FIG. 6 is a photograph showing an actual example of applying the functional detachable character patch of the present invention to a car.

FIG. 7 is a photograph showing an actual example of applying the functional detachable character patch of the present invention to a mobile phone.

FIG. 8 is a photograph showing an actual example of applying the functional detachable character patch of the present invention to a mask.

FIG. 9 is a photograph showing an actual example of applying the functional detachable character patch of the present invention to a bag.

FIG. 10 is a perspective view of a detachable accessory hat according to an example of the present invention.

FIG. 11 is an exploded perspective view of detachable accessory hat according to an example of the present invention.

FIG. 12 is a perspective view of a bag to which second attaching and detaching means 400 of the detachable accessory hat according to an example of the present invention is applied.

FIG. 13 is a perspective view of clothes to which the second attaching and detaching means 400 of the detachable accessory hat according to an example of the present invention is applied.

FIG. 14 is a perspective view of a detachable accessory hat according to another example of the present invention.

FIG. 15 is a sectional structural view of a detachable accessory hat according to another example of the present invention.

### DETAILED DESCRIPTION

Hereinafter, the present invention will be described in more detail.

The present invention provides a detachable character patch characterized in that a front surface is printed with a 3D character image or a dynamic image, and a back surface is configured of a detachable velcro.

Since the detachable character patch according to the present invention is made of velcro, it has an advantage that it may be easily attached and detached when a character is desired to be changed.

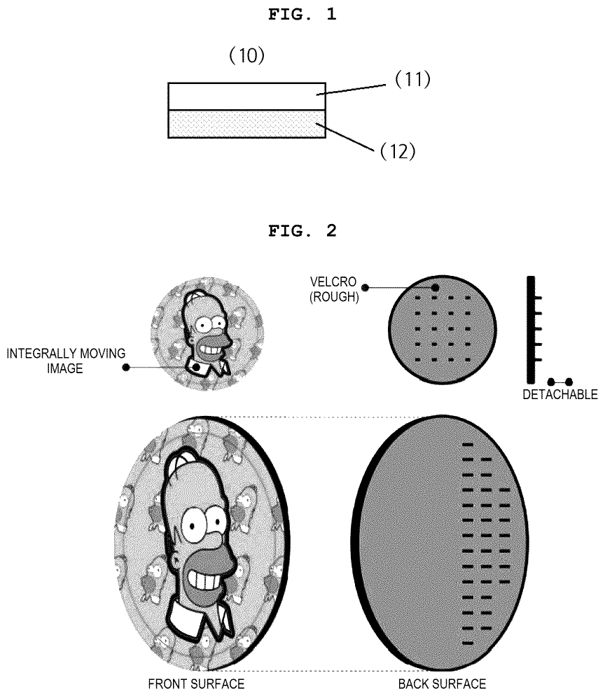

FIG. 1 is a sectional view showing the structure of the detachable character patch of the present invention, FIG. 2 is a view showing an example of the detachable character patch of the present invention.

A front surface 11 of a detachable character patch 10 of the present invention is printed with a 3D character image or a dynamic image, and a back surface 12 is configured of the detachable velcro. For example, the front surface 11 may be processed in a lenticular manner to dynamically express an image. In a case where the front surface 11 is processed in such a lenticular manner, it is possible to provide a visually excellent dynamic effect and three-dimensional effect, unlike conventional static image.

The detachable character patch may be used in various ways such as figures, letters, marks, and pictures, and there is no particular limitation thereto. A material of the detachable character patch is a flexible material, and may be easily attached and detached to and from various targets such as clothes, bags, hats, masks, and mobile phones, and may be decorated in various ways by changing the character at any time according to the degree of preference. A soft or hard material may be variously applied to the detachable character patty.

In the present specification, “velcro” means a combination of velours which means velvet in French, and crochet which means hook or clasp.

Since velcro is attached to the back surface 12 of the detachable character patch 10 of the present invention, only the detachable character patch 10 may be attached and detached to and from the base patch when the character is desired to be changed.

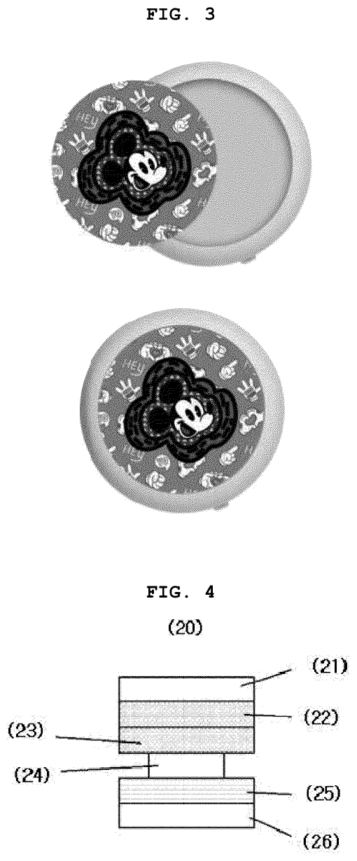

FIG. 3 shows an actual example of a structure configured of the front surface and the back surface on which characters are printed in the detachable character patch of the present invention.

Further, the present invention provides a functional detachable character patch configured of (1) a first layer having a front surface that is printed with a 3D character image or a dynamic image, and a back surface that is made of detachable velcro; (2) a second layer having a front surface that is made of velcro capable of being attached to the velcro of the first layer, and a back surface to which a layer including a functional component is attached; and (3) a third layer having a front surface that is an adhesive surface attached to the layer including the functional liquid component of the second layer, and a back surface that is configured of a base patch for mounting on an application target.

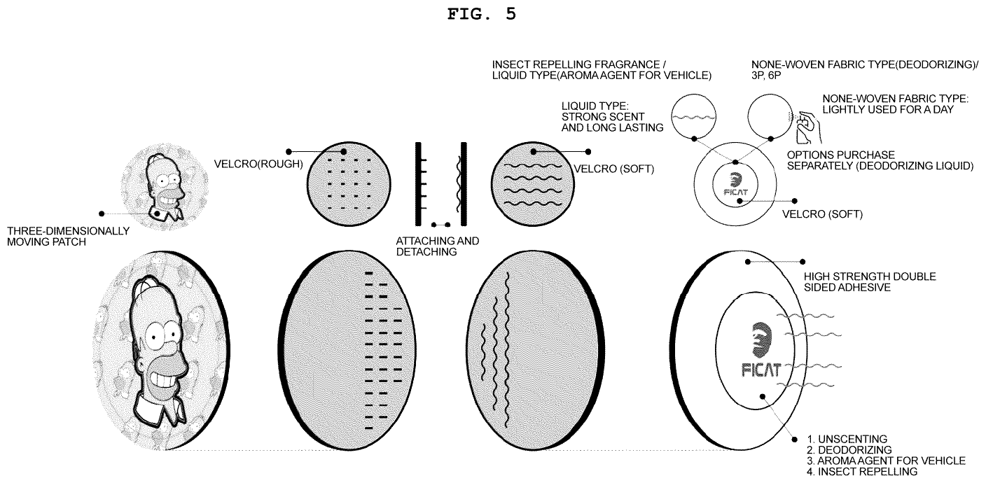

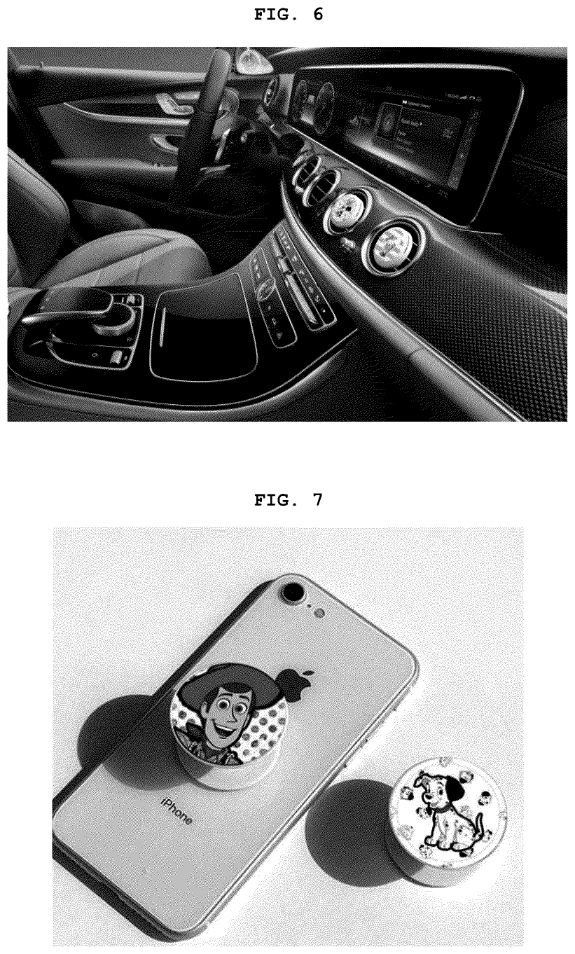

FIG. 4 is a sectional view showing a structure of the functional detachable character patch of the present invention, and FIG. 5 is a view showing an example of the functional detachable character patch of the present invention.

According to one implement example of the present invention, in a functional detachable character patch 20 of the present invention, a front surface 21 of the first layer is printed with a character 3D image or a dynamic image, and a back surface 22 is configured of a detachable velcro.

The velcro on the back surface 22 of the first layer may be velours or crochet. In a case where the velcro on the back surface 22 of the first layer is velours, the velcro on the front surface 23 of the second layer is the crochet, and in a case where the velcro on the back surface 22 of the first layer is the crochet, the velcro on the front surface 23 of the second layer is the velors.

Therefore, in the functional detachable character patch 20 of the present invention, the velours or the crochet on the back surface 22 of the first layer, and the crochet or the velours on the front surface 23 of the second layer may be attached and detached to and from each other. Therefore, whenever the character printed on the front surface 21 of the first layer is desired to be changed, only the first layer configured of the front surface 21 on which the character is printed and the back surface 22 with velcro is separated and detached, and then a new first layer on which a desired character is printed may be easily attached.

According to one implement example of the present invention, in the functional detachable character patch 20 of the present invention, the front surface 23 of the second layer is configured of the velcro that may be attached to the velcro of the first layer, and the back surface 24 is attached to the layer including a functional component.

The layer including the functional component may be a liquid layer including a volatile antibacterial component, an aromatic component, or a deodorizing component, or a fabric layer impregnated or sprayed with a volatile antibacterial component, an aromatic component, or a deodorizing component.

The fabric may be a fiber material such as natural fiber, artificial fiber or synthetic fiber, and the volatile antibacterial component, the aromatic component, or the deodorizing component is impregnated or sprayed into the fiber material.

As the volatile antibacterial component, the aromatic component, or the deodorizing component, for example, various functional components such as insect repelling fragrance, aroma fragrance, and phytocide fragrance may be used, and there is no particular limitation on the type thereof.

The volatile antibacterial component, the aromatic component, or the deodorizing component is attached to the application target and disappears by volatilization.

According to one implement example of the present invention, the back surface 24 of the second layer to which the layer including the functional component is attached and the front surface 25 of the third layer are adhered to each other.

According to one implement example of the present invention, the back surface 24 of the second layer and the front surface 25 of the third layer may be bonded and then separated repeatedly. Therefore, when the volatile antibacterial component, the aromatic component, or the deodorizing component is all lost, the adhesion between the back surface 24 of the second layer and the front surface 25 of the third layer is separated, and a new volatile antibacterial component, aromatic component, or deodorizing component is charged, an then the back surface 24 of the second layer and the front surface 25 of the third layer may be bonded again.

According to one implement example of the present invention, in the functional detachable character patch 20 of the present invention, the front surface 25 of the third layer is an adhesive surface attached to the back surface 24 including a layer containing the functional liquid component of the second layer, and the back surface 26 is configured of a base patch for mounting on an application target.

The back surface 26 of the third layer may be configured in a form that may be mounted on the application target, specifically, it may be made in a form in which an adhesive is applied or an adhesive tape is coated, or which may be inserted into a gap in the front surface of a vehicle or furniture.

According to one implement example of the present invention, the application target is clothes, bags, hats, masks, wallets, vehicles, mobile phones, electronic devices, or furniture.

Meanwhile, the present invention provides a method for decorating clothes, bags, hats, masks, wallets, vehicles, mobile phones, electronic devices, or furniture using the detachable character patch.

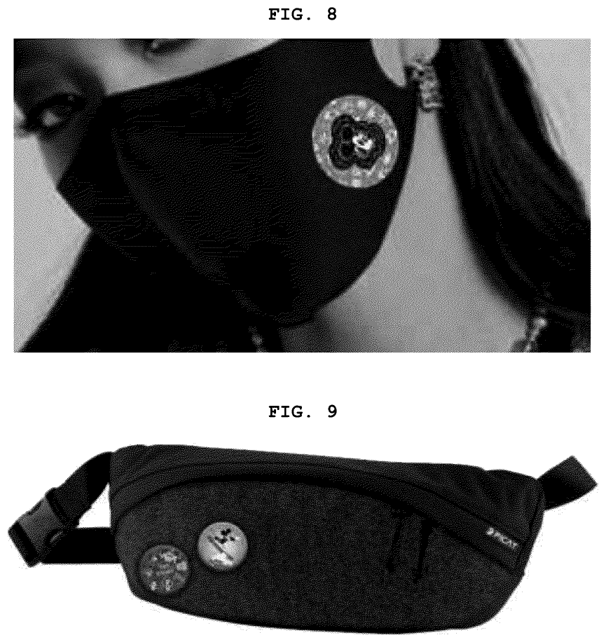

FIG. 6 is a photograph showing an actual example of applying the functional detachable character patch of the present invention to a car, FIG. 7 is a photograph showing an actual example of applying the functional detachable character patch of the present invention to a mobile phone,

FIG. 8 is a photograph showing an actual example of applying the functional detachable character patch of the present invention to a mask, and FIG. 9 is a photograph showing an actual example of applying the functional detachable character patch of the present invention to a bag.

On the other hand, in the present invention, a detachable accessory hat is provided, which includes a cap body 100 formed of a hemispherical body portion 110, and configured of a cap portion 120 protruding forward from a lower end of the body portion 110;
a cap decoration 200 mounted on the cap body 100, made in a thin and flat shape so as to be capable of being easily bent and adhered to the cap body 100 when mounted on the cap body 100, and made of a fibrous material;
a first attaching and detaching means 300 mounted on the hat decoration 200, made of a nylon material by mold injection, and having a plurality of plastic hook protrusions 310 formed on a front surface thereof;
a second attaching and detaching means 400 mounted on the hat body 100 and having a plurality of loops 410 formed by weaving a polyester material by a knitting method and then performing nap processing; and
a third attaching and detaching means 500 where an opening 150 is openly formed in the hat body 100, and which is provided inside the hat body 100 along a circumference of the opening 150,
in the third attaching and detaching means 500, a plurality of loops are formed through nap processing after weaving the fabric by a knitting method, the second attaching and detaching means 400 includes
an exposed portion 400a to which the hat decoration 200 is detachably coupled; and
a coupling portion 400b provided along a circumference of the exposed portion 400a and detachably coupled to the third attaching and detaching means 500, and
the hook protrusion 310 includes
a plurality of support portions 311 formed by
protruding upward and spaced apart from each other at regular intervals; and
a locking portion 312 protruding away from a front end of the support portion 311 in a width direction and formed in an upwardly convex arc shape.

According to one implement example of the present invention, a hat decoration 200 made of the fiber material is the detachable character patch.

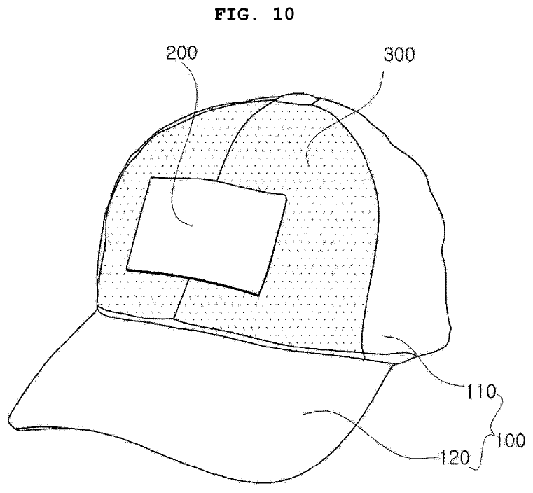

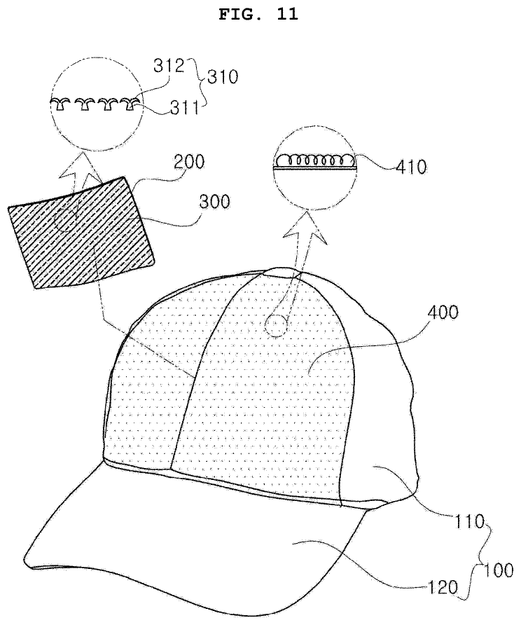

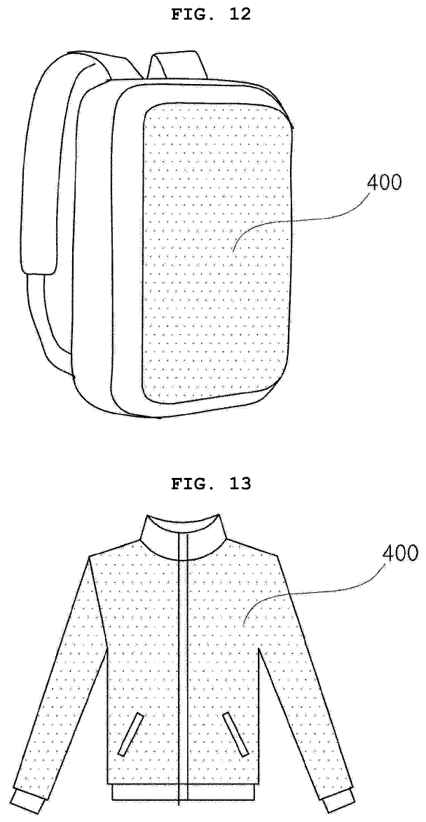

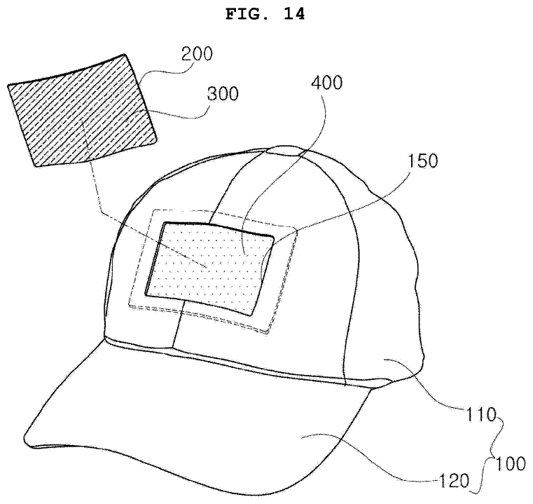

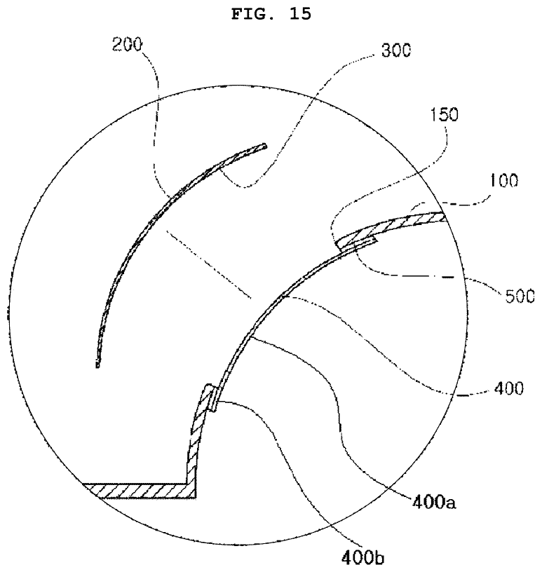

FIG. 10 is a perspective view of a detachable accessory hat to an example of the present invention. FIG. 11 is an exploded perspective view of a detachable accessory hat according to an example of the present invention. FIG. 12 is a perspective view of a bag to which second attaching and detaching means 400 of the detachable accessory hat according to an example of the present invention is applied. FIG. 13 is a perspective view of clothes to which the second attaching and detaching means 400 of the detachable accessory hat according to an example of the present invention is applied. FIG. 14 is a perspective view of a detachable accessory hat according to another example of the present invention. FIG. 15 is a sectional structural view of a detachable accessory hat according to another example of the present invention.

As shown in FIGS. 10 to 11, the detachable accessory hat according to the example of the present invention includes the hat body 100, the hat decoration 200, the first attaching and detaching means 300, and the second attaching and detaching means 400.

As shown in FIG. 10, the hat body 100 is made of a cap-shaped hat, and includes a hemispherical body portion 110 and a cap portion 120 protruding forward from a lower end of the body portion 110.

The front portion of the body portion 110 is provided with the second attaching and detaching means 400 to attach and detach the hat decoration 200.

Of course, the second attaching and detaching means 400 may be provided on the entire body portion 110, may be provided only on a part such as the rear portion or the side portion, and may also be provided on the cap portion 120.

The hat decoration 200 is made in a thin and flat shape so that it may be easily bent and adhered when being mounted on the hat body 100, and is made of a fiber material.

In addition, on one surface of the hat decoration 200, various letters, phrases, characters, or pictures are designed by embroidery.

Of course, depending on the case, the hat decoration 200 may express various designs through various materials such as fiber, non-woven fabric, metal, silicon, rubber, and plastic, and various processing methods.

In addition, the other surface of the hat decoration 200 is provided with the first attaching and detaching means 300, which will be described later, and is detachably mounted on the hat body 100 by the first attaching and detaching means 300.

That is, the hat decoration 200 is detachably mounted on the hat body 100 provided with the second attaching and detaching means 400 which is to be described later, may be attached to the body portion 110 of the hat body 100 by selecting a design suitable for coordinating with clothes, and may be easily replaced according to the preference.

On the other hand, the first attaching and detaching means 300 is provided on an outer surface of the hat decoration 200, and is made of nylon material, and is a plastic velcro made by a mold injection method.

More specifically, as shown in FIG. 11, the first attaching and detaching means 300 is provided on the other surface of the hat decoration 200, and a plurality of plastic hook protrusions 310 are formed on the front surface.

The hook protrusion s310 are entangled with each other when coming into contact with the loops 410 of the second attaching and detaching means 400, which will be described later, and coupled with the target, and configured of the support portions 311 and the locking portions 312.

A plurality of support portions 311 are formed to protrude upward, and are spaced apart from each other at regular intervals. The locking portions 312 are formed to protrude in directions opposite to each other at the front end of the support portions 311, and are formed in a shape of a convex arc.

The hook protrusions 310 are formed very finely and are not easily visible with naked eyes, are formed of a plurality of pieces, and are spaced apart from each other at regular intervals.

Since the first attaching and detaching means 300 does not have a base fabric, a thickness thereof is thinner than that of the conventional velcro, and as a result, when the hat decoration 200 is attached to the hat body 100, the protrusion of the hat decoration 200 is minimized, and the sense of difference between the hat body 100 and the fabric is reduced, thereby improving marketability and expandability.

The second attaching and detaching means 400 is provided on the outer surface of the hat body 100 and is made of a polyester material, and after weaving the fabric by a knitting method, the loops 410 are formed through nap processing.

Here, knitted fabric means a fabric made by weaving two or more yarns like knitting, such as a knit or a sweater, and the nap processing means that the woolen fabric is thickened by shrinking and raised to make the loop 410 as long as possible, and the loop 410 is processed into a bead shape or wavy shape by an external force.

In this way, since the second attaching and detaching means 400 is woven by a knitting method, it is easy to apply to curved products such as hats due to the characteristics of the knitted fabric having excellent elasticity, and there is an advantage in that the hat is easy to manufacture.

In addition, compared to the conventional velcro, the degree of the loop 410 is less, and it has the aesthetics of a knitted material, so there is less the sense of difference from the fabric mainly used for hats, bags, clothes, etc., and thereby this has the effect of increasing material merchantability and expandability.

In this way, in detachable accessory hat according to the example of the present invention, the hat decoration 200 is provided with the first attaching and detaching means 300, and the hat body 100 is provided with the second attaching and detaching means (400), so that it is possible to conveniently replace and wear various hat decorations 200 desired by the wearer according to the clothes, thereby improving the wearer's satisfaction.

In addition, the first attaching and detaching means 300 has a plurality of plastic hook protrusions 310 formed on the front surface by a mold injection method, and the second attaching and detaching means 400 is made by using the fabric woven by the knitting method. Therefore, the purpose is to minimize the protruding height when attaching the hat decoration 200 to lower the sense of difference, and to provide the detachable decoration hat with improved marketability.

In addition, the second attaching and detaching means 400 according to an example of the present invention, as shown in FIGS. 12 and 13, may also be used when applying the detachable decoration to bags or clothes.

Meanwhile, as shown in FIGS. 14 and 15, the second attaching and detaching means 400 may be mounted on the cap body 100 in a replaceable manner.

Specifically, the cap body 100 has an opening 150 openly formed, and is provided with third attaching and detaching means 500 inside the cap body 100 along the circumference of the opening 150.

The third attaching and detaching means 500 has a plurality of loops formed on the front surface, and is formed of the same material and method as those of the second attaching and detaching means 400.

In addition, the second attaching and detaching means 400 is divided into an exposed portion 400a to which the hat decoration 200 is detachably coupled and a coupling portion 400b that is provided along the circumference of the exposed portion 400a and is detachably coupled to the third attaching and detaching means 500.

In the second attaching and detaching means 400, the coupling portion 400b is attached to the third attaching and detaching means 500 and coupled to the hat body 100, and the exposed portion 400a is attached to the hat decoration 200.

If the second attaching and detaching means 400 is used for a long period of time and the adhesion is reduced or the front surface is damaged, there is an effect that the second attaching and detaching means 400 may be separated from the hat body 100 and easily replaced.

As described above, since the detachable character patch according to the present invention is made of velcro, it has an advantage that it may be easily attached and detached when a character is desired to be changed. In addition, the functional detachable character patch of the present invention configured of the first layer having the front surface that includes the image and the back surface that is made of the velcro; the second layer having the front surface that is made of velcro capable of being attached to the velcro of the first layer and the back surface to which the layer including a functional liquid component attached; and (3) the third layer having the front surface that is the adhesive surface attached to the back surface of the second layer and the back surface that is configured of the base patch for mounting on the application target includes the functional components such as the volatile antibacterial component, the aromatic component, or the deodorizing component. Therefore, the functional detachable character patch may be easily applied to various targets such as clothes, bags, hats, masks, vehicles, mobile phones, electronic devices, or furniture. Accordingly, the detachable character patch according to the present invention is easy to attach and detach, so that anyone may easily decorate clothes, bags, hats, masks, mobile phones, etc. in various ways according to the degree of preference, and may easily change the character at any time. In addition, the functional detachable character patch may be applied to various targets such as clothes, bags, hats, masks, vehicles, mobile phones, electronic devices, or furniture to obtain desired functional effects, and may be expected to be very useful in the relevant field.

Hereinafter, examples and the like will be described in detail to aid understanding of the present invention. However, the examples according to the present invention may be modified in many different forms, and the scope of the present invention should not be construed as being limited to the following examples. Examples of the present invention are provided to more completely explain the present invention to those skilled in the art.

### <Example 1> Evaluation of the Degree of Preference of Functional Detachable Character Patches

The degree of preference for the functional detachable character patch according to the present invention was evaluated.

20 teenagers and 20 adults were evaluated for the ease of attaching and detaching and overall satisfaction with the functional detachable character patch according to the present invention and the existing character patch for comparison. The results are shown in Table 1 below.

As a test method, a 5-point comparison scale method was used, 5-point for very good, 4-point for good, 3-point for average, 2-point for dislike, and 1-point for very dislike. The arithmetic mean value was calculated by summing the final responses.

TABLE 1

| | Functional | |
|---|---|---|
| | detachable | |
| | character patch | |
| | according to | Existing character |
| | present invention | patch |
| Ease of attaching | 5.0 | 1.2 |
| and detaching | | |
| Overall | 5.0 | 1.2 |
| satisfaction | | |

As shown in Table 1, the functional detachable character patch according to the present invention showed very high ease of attachment and detachment and overall satisfaction compared with the existing character patch.

Since the specific parts of the present invention have been described in detail above, it is clear that these specific techniques are merely preferred implement examples for those skilled in the art, and the scope of the present invention is not limited thereto. Accordingly, the substantial scope of the present invention will be defined by the appended claims and equivalents thereof.

1. A detachable character patch wherein a front surface is printed with a character 3D image or a dynamic image, and a back surface is configured of a detachable velcro.

2. A method for decorating clothes, bags, hats, masks, wallets, vehicles, mobile phones, electronic devices, or furniture by using the detachable character patch according to claim 1.

3. A functional detachable character patch comprising:
a first layer having a front surface that is printed with a 3D character image or a dynamic image, and a back surface that is made of detachable velcro;
a second layer having a front surface that is made of velcro capable of being attached to the velcro of the first layer, and a back surface to which a layer including a functional component is attached; and
a third layer having a front surface that is an adhesive surface attached to the layer including the functional component of the second layer, and a back surface that is configured of a base patch for mounting on an application target.

4. The functional detachable character patch according to claim 3, wherein when the velcro on the back surface of the first layer is velours, the velcro on the front surface of the second layer is a crochet, and when the velcro on the back surface of the first layer is crochet, the velcro on the front surface of the second layer is velours.

5. The functional detachable character patch according to claim 3, wherein the layer including the functional component is a liquid layer including a volatile antibacterial component, an aromatic component, or a deodorizing component, or a fabric layer impregnated or sprayed with a volatile antibacterial component, an aromatic component, or a deodorizing component.

6. A method for decorating clothes, bags, hats, masks, wallets, vehicles, mobile phones, electronic devices, or furniture by using the functional detachable character patch according to claim 3.

7. A detachable accessory hat decorated by using the detachable character patch according to claim 1.

8. A detachable accessory hat decorated by using the functional detachable character patch according to claim 3

9. The detachable accessory hat according to claim 7, wherein the hat comprising:
a cap body formed of a hemispherical body portion, and configured of a cap portion protruding forward from a lower end of the body portion;
a detachable character patch mounted on the cap body, made in a thin and flat shape so as to be capable of being easily bent and adhered to the cap body when mounted on the cap body;
a first attaching and detaching means mounted on the detachable character patch, made of nylon by mold injection, and having a plurality of plastic hook protrusions formed on a front surface thereof;
a second attaching and detaching means mounted on the hat body and having a plurality of loops formed by weaving a polyester material by a knitting method and then performing nap processing; and
a third attaching and detaching means where an opening is openly formed in the hat body, and which is provided inside the hat body along a circumference of the opening,
in the third attaching and detaching means, a plurality of loops are formed through nap processing after weaving the fabric by a knitting method,
second attaching and detaching means includes
an exposed portion to which the hat decoration is detachably coupled; and
a coupling portion provided along a circumference of the exposed portion and detachably coupled to the third attaching and detaching means, and
the hook protrusion includes
a plurality of support portions formed by protruding upward and spaced apart from each other at regular intervals; and
a locking portion protruding away from a front end of the support portion in a width direction and formed in an upwardly convex arc shape.

10. The detachable accessory hat according to claim 8, wherein the hat comprising:
a cap body formed of a hemispherical body portion, and configured of a cap portion protruding forward from a lower end of the body portion;
a detachable character patch mounted on the cap body, made in a thin and flat shape so as to be capable of being easily bent and adhered to the cap body-when mounted on the cap body;
a first attaching and detaching means mounted on the detachable character patch, made of nylon by mold injection, and having a plurality of plastic hook protrusions formed on a front surface thereof;
a second attaching and detaching means mounted on the hat body and having a plurality of loops formed by weaving a polyester material by a knitting method and then performing nap processing; and
a third attaching and detaching means where an opening is openly formed in the hat body, and which is provided inside the hat body along a circumference of the opening,
in the third attaching and detaching means, a plurality of loops are formed through nap processing after weaving the fabric by a knitting method,
the second attaching and detaching means includes
an exposed portion to which the hat decoration is detachably coupled; and
a coupling portion provided along a circumference of the exposed portion and detachably coupled to the third attaching and detaching means, and
the hook protrusion includes
a plurality of support portions formed by protruding upward and spaced apart from each other at regular intervals; and
a locking portion protruding away from a front end of the support portion in a width direction and formed in an upwardly convex arc shape.
